(19) United States
(12) Patent Application Publication
(10) Pub. No.: US 2009/0218832 A1
(43) Pub. Date: Sep. 3, 2009

(54) Door Strike

(75) Inventor: Michael Trevor Mackle, Matraville (AU)

Correspondence Address: WOLF GREENFIELD & SACKS, P.C., 600 ATLANTIC AVENUE, BOSTON, MA, 02210-2206, US

(73) Assignee: Shanghhai One Top Corporation, Shanghai (CN)

(21) Appl. No.: 12/224,245

(22) PCT Filed: Jan. 31, 2007
(86) PCT No.: PCT/AU2007/000089

§ 371 Date: Jan. 12, 2009

(30) Foreign Application Priority Data
Feb. 23, 2006 (AU) 2006900906

(51) Int. Cl. E05B 15/02

(52) U.S. Cl. 292/340; 70/275

(57) ABSTRACT

A door strike comprising: a body; a retaining means for retaining a latch bolt, the retaining means being movable with respect to the body between a latch bolt retaining position and a latch bolt releasing position; a locking means for releasably locking the retaining means in the latch bolt retaining position; and detecting means for detecting removal of the body from a door frame.

### FIELD OF THE INVENTION

The present invention relates generally to the field of door strikes, and more particularly the field of electric door strikes that can be mounted to a door frame.

### BACKGROUND OF THE INVENTION

A door strike is a device for releasably retaining a latch bolt mounted to a door. Door strikes, particularly the electrically operated variety, are commonly used in office buildings where they provide control over ingress and egress of persons via doors of the building.

While existing door strikes are relatively effective at controlling ingress and egress of persons via doors, they can in some instances be susceptible to being tampered with by persons seeking unauthorised access to a building. In this regard, persons seeking unauthorised access may try to completely remove a strike from the doorframe to which it is fitted so that the associated door can be freely opened. In some cases a door strike can be removed from a door frame by simply unscrewing a couple of screws that hold the strike to the frame.

### SUMMARY OF THE INVENTION

Accordingly, the present invention provides a door strike comprising:

a body;

a retaining means for retaining a latch bolt, the retaining means being movable with respect to the body between a latch bolt retaining position and a latch bolt releasing position;

a locking means for releasably locking the retaining means in the latch bolt retaining position; and

detecting means for detecting removal of the body from a door frame.

Unlike existing door strikes, an embodiment of the door strike according to the present invention has the advantage of being able to detect removal of the strike body from the door frame, which maybe done by a person trying to gain unauthorised access to a premises by removing the strike in an attempt to easily open a door controlled by the strike.

Preferably, the detecting means comprises a switch having an actuator that is arranged to move from a first position to a second position when the body is removed from the door frame.

Using the switch in the embodiment of the door strike according to the present invention provides a simple, reliable and cost effective detection mechanism.

Alternatively, instead of using the switch it is envisaged that the detecting means could be in the form of, for example, a magnetic reed switch, hall effect device, proximity detector, or photo-electric device.

Preferably, the locking means is movable relative to the body from a fail safe position, in which the door strike provides fail safe operation, and a fail secure position, in which the door strike provides a fail secure operation.

Allowing the locking means to be moved between the fail safe position and the fail secure position in the embodiment of the door strike according to the present invention provides the advantage of providing a versatile single strike that can operate in either mode (that is; fail safe or fail secure).

Preferably, the strike comprises a removable part that is arranged to be fitted to an outer surface of the body and which can be removed from the body to gain access to the locking means so to enable the locking means to be moved between the fail safe position and the fail secure position.

Use of the removable part in the embodiment of the strike according to the present invention is advantageous because it provides a cover for the fastening devices (for example, screws) that are used to hold the locking means in position. The fastening devices are such that they can be loosened to allow the locking means to be moved between the fail safe and fail secure modes of operation. By acting as a cover the removable part serves several purposes: first, it protects the fastening devices from any damage that may otherwise occur as the strike is being fitted or removed from a doorframe; second, it makes it a little more difficult for an unauthorised person to gain access to the fastening device(s) (holding the locking means in position), which the person make seek in an attempt to render the strike ineffective.

### A BRIEF DESCRIPTION OF THE DRAWINGS

Notwithstanding any other embodiments that may fall within the scope of the present invention, an embodiment of the present invention will now be described, by way of example only, with reference to the accompanying figures, in which FIGS. (1a) to 1(h) provide various illustrations of a door strike according to an embodiment of the present invention.

### AN EMBODIMENT OF THE INVENTION

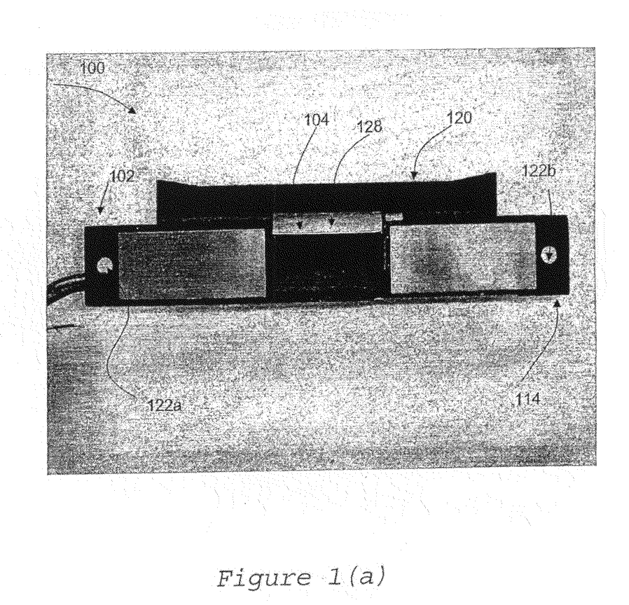

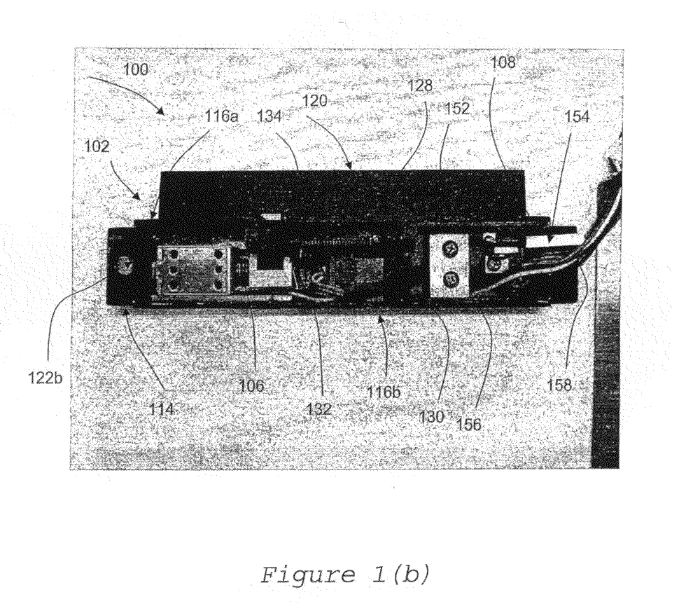

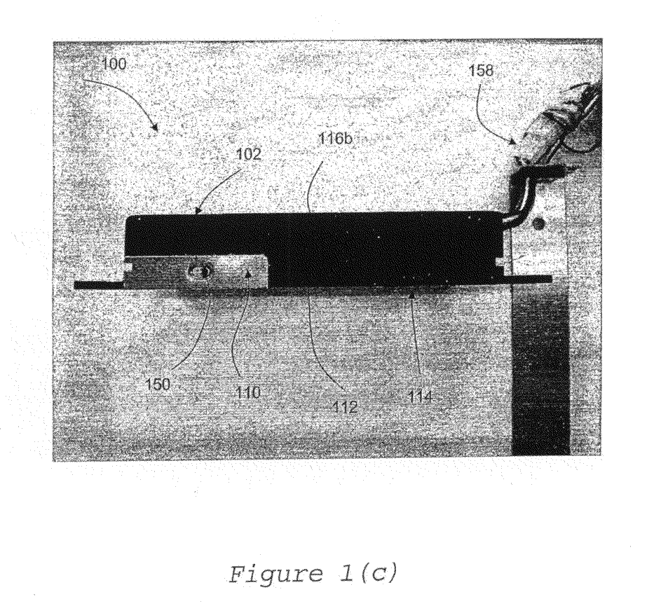

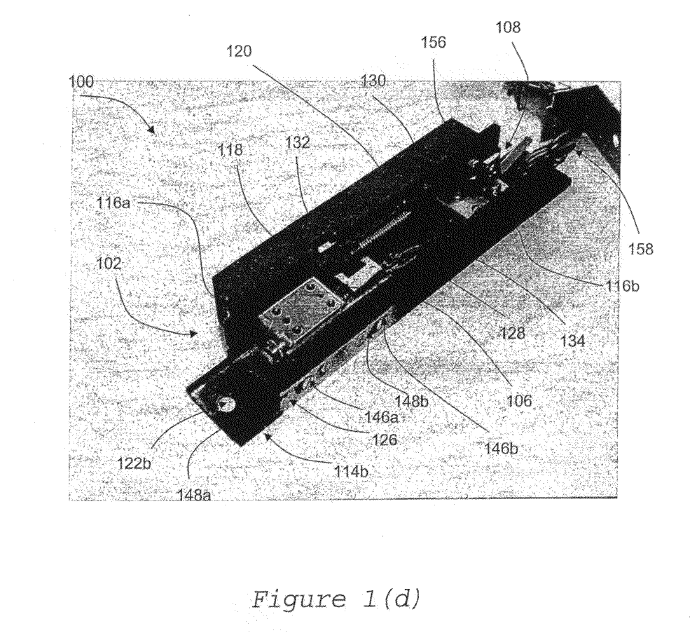

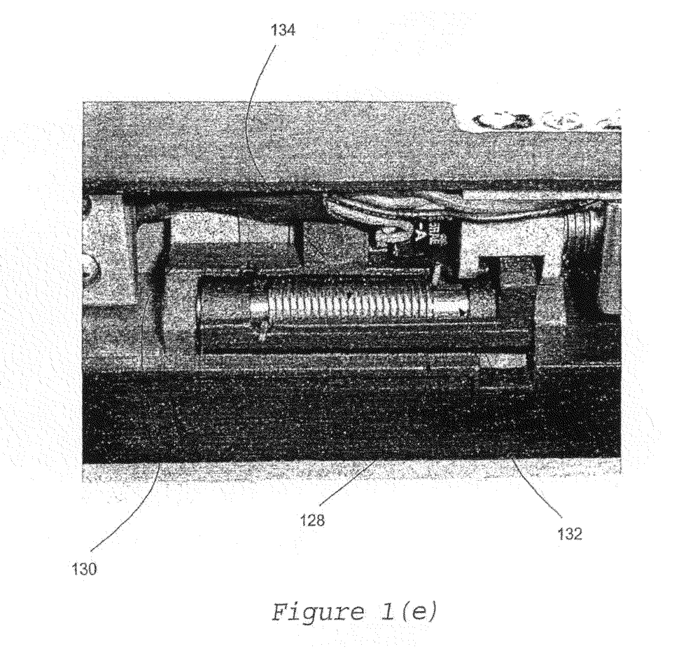

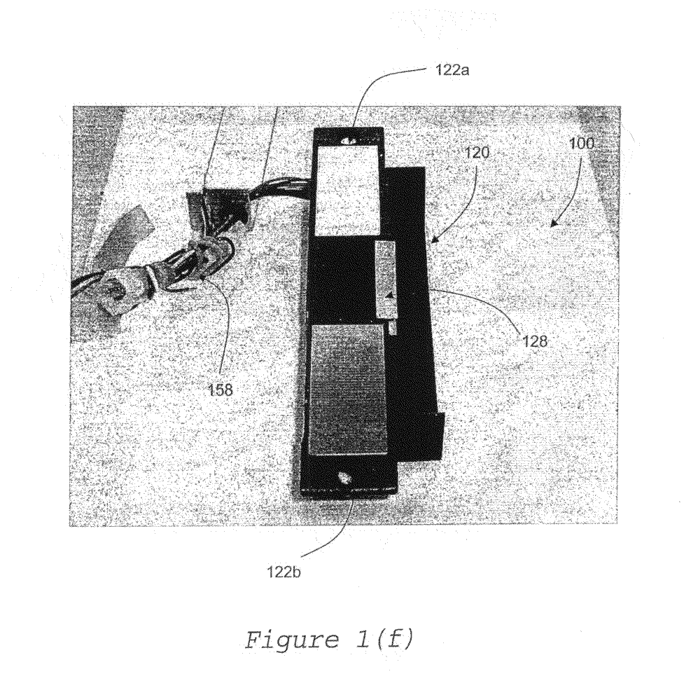

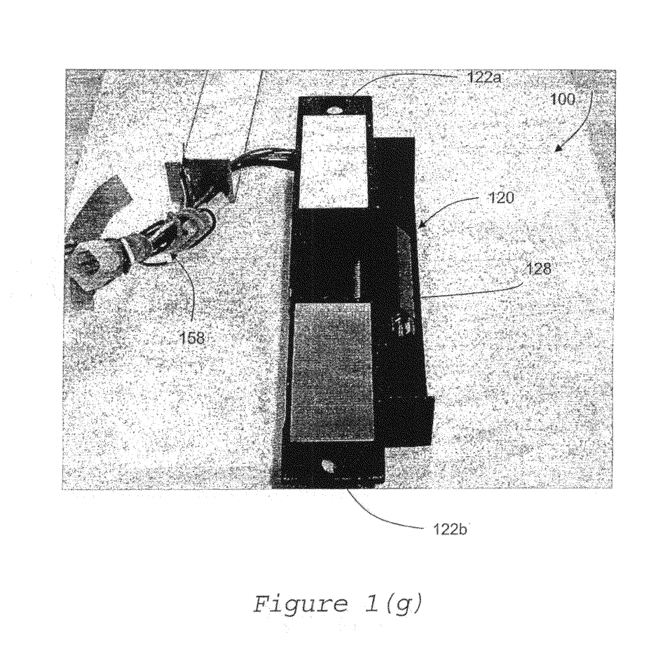

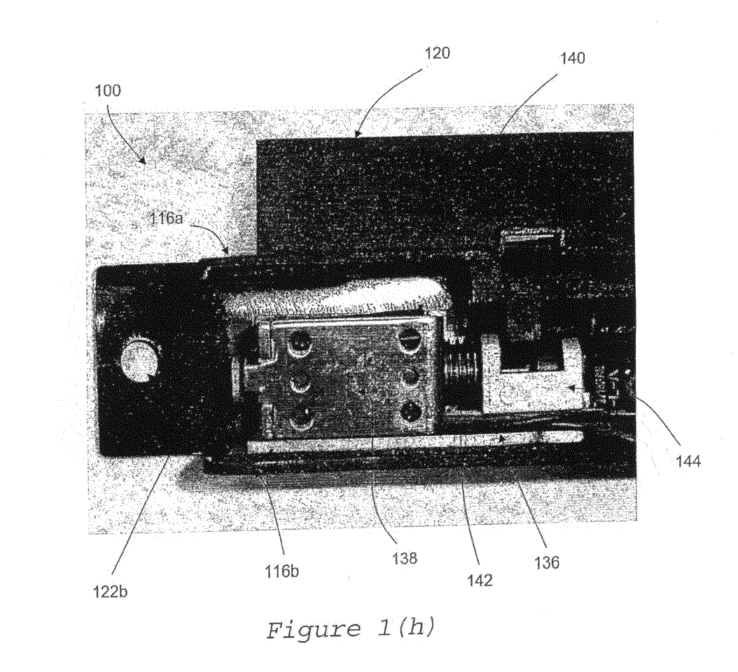

With reference to FIG. 1(a), which illustrates a door strike 100 in accordance with an embodiment of the present invention, the door strike 100 comprises a body 102 and a retaining means 104 that is pivotally mounted to the body 102. As can be seen in FIG. 1(b), the door strike 100 also comprises a locking means 106 that is slidably mounted to the body 102 and a detecting means 108 that is mounted to the body 102. Furthermore, as shown in FIG. 1(c) the door strike 100 also comprises a removable part 110 that is mounted to an outer surface 112 of the body 102.

With reference to FIG. 1(d), the body 102 of the strike 100 is made from a cast metal material and comprises: a front face portion 114; two side portions 116 that extend outwardly from the front face portion 114 to define a void 118, in which the locking means 106 and the detecting means 108 reside; and a mounting portion 120 that extends outwardly from one of the side portions 116a. As can be seen in FIG. 1(a), each end of the front face portion 114 has an aperture 122 for receiving a screw that is used to secure the body 102 to a door frame. In addition to the apertures 122, the front face portion 114 also has a recessed portion 124 for receiving a latch bolt mounted to a door. As can be seen in FIG. 1(d), one of the side portions 116b has a grooved section 126 for receiving the removable part 110.

With reference to FIGS. 1(a) and 1(e), the retaining means 104 comprises: a cast metal element 128; a mounting 130 that is coupled to the body 102; a pin 132 that is coupled to the cast metal element 128 and the mounting 130; and a spring 134 that is fitted to the pin 132. The cast metal element 128 is pivotally mounted to the body 102 such that it is pivotally movable with respect to the body 102 between a latch bolt retaining position and a latch bolt releasing position. In the latch bolt retaining position, which is illustrated in FIG. 1(f), the cast metal element 128 obstructs the latch bolt when located in the recessed portion 124 in the front face portion 114 of the body 102 such that it cannot be readily removed from the recessed portion 124. In the latch bolt releasing position, which is illustrated in FIG. 1(g), the cast metal element 128 is such that it does not obstruct the latch bolt when located in the recessed portion 124 in the front face portion 114 of the body 102 such that it can be readily removed from the recessed portion 124.

In relation to the mounting 130, which is made of a cast metal, and the pin 132 which is made from machined steel, these components 130 and 132 of the strike 100 are arranged to pivotally mount the cast metal element 128 to the body 102. The spring 134, which is made from metal, is fitted over the pin 132 and is arranged to urge the cast metal element 128 from the latch bolt releasing position towards the latch bolt retaining position.

Referring to FIG. 1(h), the locking means 106 comprises: a metal base plate 136, which is mounted to one of the side portions 116b of the body 102 and which is located in the void 118; an electrically activated solenoid 138 that is fixed to the base plate 136; and an obstructing assembly 140, which comprises a metal obstructing member 142 and a housing 144 that houses the obstructing member 142 and which is secured to the base plate 136. As can be seen in FIG. 1(d), the base plate 136 is secured to the side portion 116 of the body 102 by two screws 146 that are located in slots 148 in the grooved section 126 of one of the side portions 116b of the body 102. In order to switch the strike 100 between fail safe and fail secure modes of operation, a person needs to first remove the removable part 110 from the grooved section 126 (which effectively involves disassembling the strike 100) to gain access to the two screws 146. To remove the removable part 110 from the grooved section 126 the person unscrews the screw 150, which secures the removable part 110 to the side portion 116. Once the person has removed the removable part 110 from the grooved section 126, the person can loosen the two screws 146 to slide the locking means 106, relative to the side portion 116 of the body 102, between a fail safe position and a fail secure position.

As mentioned previously, the locking means 106 comprises an electrically activated solenoid 138 (powered from either a 6 volt or 12 volt source). When an electric current passes through the solenoid 138, the solenoid 138 moves the obstructing member 142 so as to lock the element 128 of the retaining means 104 in the latch bolt retaining position so that a latch bolt located in the recessed portion 124 of the front face portion 114 cannot be readily removed therefrom. In this regard, when the solenoid 138 moves the obstructing member 142 so as to lock the element 128 in the latch bolt retaining position, the locking means 106 provides a fail secure mode of operating. Alternatively, when the electric current passes through the solenoid 138 it can also move the obstructing member 142 out of the path of the element 128 such that the element 128 can be moved from the latch bolt retaining position to the latch bolt releasing position. In this mode of operation, which is referred to as fail secure, the obstructing member 142 is such that it locks the element 128 in the latch bolt retaining position when the solenoid 138 does not have an electric current passing therethrough.

As indicated previously, the strike 100 comprises a detecting means 108. The detecting means 108 is in the form of a single-pole-double-throw (SPDT) micro-switch. With reference to FIG. 1(b), the body 152 of the micro-switch is located in the void 118 of the body 102, while the actuator 154 of the micro-switch projects outwardly from the void 118. When the strike 100 is fitted to a doorframe the actuator 154 is ‘sandwiched’ between the doorframe and the front face portion 114 of the body 102 such that the actuator 154 is held in a first position. However, when the strike 100 is removed from the doorframe the actuator 154 moves from the first position to a second position as the actuator 154 is no longer sandwiched between the doorframe and the front face portion 114. As persons skilled in the art will readily appreciate, movement of the actuator 154 from the first position to the second position causes the electric circuit between the terminals 156 (which can bee seen in FIGS. 1(b) and 1(d)) of the micro-switch to change accordingly. It is the change in the electric circuit between the terminals 156 that enable the detecting means 108 to provide an alert that the switch 100 has been removed. In this regard, the micro-switch can be wired to a security console that issues, for example, an alarm (in response to the change in the electric circuit between the terminals 156) warning the console operator that the strike 100 has been removed from the doorframe.

In order to provide the solenoid 138 with a source of current and to detect a change in the electrical circuit at the terminals 156 of the detecting means 108, the switch 100 comprises a wiring loom 158, which can be seen in FIG. 1(f).

While the present invention has been described with reference to the aforementioned embodiment, it will be understood by those skilled in the art that alterations, changes and improvements may be made and equivalents may be substituted for the elements thereof and steps thereof without departing from the scope of the present invention. In addition, many modifications may be made to adapt to a particular situation or material to the teachings of the present invention without departing from the central scope thereof. Such alterations, changes, modifications and improvements, though not expressly described above, are nevertheless intended and implied to be within the scope and spirit of the invention. Therefore, it is intended that the invention not be limited to the particular embodiments disclosed as the embodiment for carrying out this invention, but that the invention will include all embodiments falling within the scope of the independent claims.

It will be readily appreciated by those skilled in the art that the present invention is not limited to use of a detecting means 108 in the form of a micro-switch. Persons skilled in the art will appreciate that in alternative embodiments the detecting means 108 can be in the form of, for example, a magnetic reed switch, a hall effect device, a proximity detector, or photo-electric device.

1. A door strike comprising: a body; a retaining means for retaining a latch bolt, the retaining means being movable with respect to the body between a latch bolt retaining position and a latch bolt releasing position; a locking means for releasably locking the retaining means in the latch bolt retaining position; and detecting means for detecting removal of the body from a door frame.

2. The door strike as claimed in claim 1, wherein the detecting means comprises a switch having an actuator that is arranged to move from a first position to a second position when the body is removed from the door frame.

3. The door strike as claimed in claim 1, wherein the locking means is movable relative to the body from a fail safe position, in which the door strike provides fail safe operation, and a fail secure position, in which the door strike provides a fail secure operation.

4. The door strike as claimed in claim 3, comprising a removable part that is arranged to be fitted to an outer surface of the body and which can be removed from the body to gain access to the locking means so to enable the locking means to be moved between the fail safe position and the fail secure position.

5. (canceled)

6. The door strike as claimed in claim 2, wherein the locking means is movable relative to the body from a fail safe position, in which the door strike provides fail safe operation, and a fail secure position, in which the door strike provides a fail secure operation.

7. The door strike as claimed in claim 6, comprising a removable part that is arranged to be fitted to an outer surface of the body and which can be removed from the body to gain access to the locking means so to enable the locking means to be moved between the fail safe position and the fail secure position.
